(19) United States
(12) Patent Application Publication
(10) Pub. No.: US 2026/0152431 A1
(43) Pub. Date: Jun. 4, 2026

(54) HIGH-SPEED ROTOR

(71) Applicant: ROCKWOOL A/S, Hedehusene (DK)

(72) Inventors: Jens Jørren SØRENSEN, Kastrup (DK); Christian DIEDERICHSEN, Roskilde (DK); Martin PEDERSEN, Næstved (DK)

(21) Appl. No.: 19/123,000

(22) PCT Filed: Oct. 19, 2023
(86) PCT No.: PCT/EP2023/079136

§ 371 Date: Apr. 21, 2025

(30) Foreign Application Priority Data
Oct. 21, 2022 (EP) 22203124.7

(51) Int. Cl. F16F 9/12; F16F 9/14; F16F 15/14

(52) U.S. Cl. CPC C03B 37/055

(57) ABSTRACT

A rotor for a fiberising apparatus comprising a rotor housing; a drive end and a non-drive end bearing assembly, wherein each bearing assembly comprises a plurality of ball bearings, each seated in a respective bearing seat; a substantially horizontal shaft rotatably mounted between the drive end bearing assembly and the non-drive end bearing assembly; a drive end damper ring connected to the drive end bearing assembly and a non-drive end damper ring connected to the non-drive end bearing assembly, wherein each damper ring comprises one or more resilient dampers arranged in an annular ring, wherein the or each resilient damper is connected at a first end to the bearing seat and connected at a second end to the inner wall of the rotor housing; characterised in that the stiffness of the drive end damper ring is greater than the stiffness of the non-drive end damper ring.

The present invention relates to an improved rotor and, in particular, relates to a rotor for a fiberising apparatus for use in the manufacture of man-made vitreous fibres (MMVF), and a method of manufacture of man-made vitreous fibres (MMVF).

Spinning devices, known as fiberising apparatus or (cascade) spinners, are used for the manufacture of MMVF to produce insulation material; for example, to provide acoustic or heat insulating material from a mineral melt of stone or rock or a slag or glass melt. The fiberising apparatus have a set of rotors to spin the molten material or lava over a spinning wheel to produce a web-like insulation product. The molten stone or lava (“the melt”) is thrown successively from a first rotor to the remaining rotors of the set and fibres are thrown off each wheel as each of the rotors rotate. The fibres are collected and carried away from the set of rotors for the manufacture of insulation products, such as stone wool insulation products.

The rotors within the spinners operate at very high speed. The control of the high speed and high acceleration force of the spinner controls the physical and performance characteristics of the fibres and so the insulation that is produced. It has been found that by increasing the speed and acceleration of the spinning device, the spun fibres can be made thinner and softer with improved and highly desirable heat insulation properties. It has been found that conduction in the spun fibre is less if the fibre is thinner and more air is held within an insulation product if it is made up of thinner fibres.

Known spinners operate at high speeds and accelerations of around 150 km/s² to achieve the required very thin fibres for good heat insulation properties. Each rotor wheel comprises a rotating shaft suspended between bearings at each of a drive end (DE) and a non-drive end (NDE). The NDE and DE of the rotor are not equidistant from the respective ends of the shaft because the shaft at the NDE passes beyond the rotor to the wheel onto which molten material is directed. The NDE of the shaft effectively overhangs the bearings and it has been found that the NDE of the rotor has the highest load. Vibration of the rotor mechanics at the DE and NDE during spinning causes significant wear on the bearings seated at each end of the rotor and wear on any dampers placed between the rotor housing and the spinner body. Known devices use dampers positioned between the rotor housing and the spinner body to reduce vibrations being passed from one rotor to other rotors in the set.

However, the scale and speeds of spinning of fiberising apparatus exert a very high load on the bearings used and so require worn bearings to be frequently replaced. Typically, a four-wheel spinner with which the rotor of the present invention is used produces 5-6 tonnes of stone wool per hour, such that any reduction in “down time” due to maintenance significantly increases the volume of product that can be produced.

The rotors in the fiberising spinners are each arranged about a substantially horizontal axis, such that there is a contribution to wear on the rotor bearings because gravity contributes to an unbalance, which leads to variable wear on the bearings. It has also been found that an unbalance in the forces exerted on each rotor is caused by the melt being thrown onto the rotor wheel. Any uneven wearing of the rotor mechanics or wearing of the external surface of the rotor assembly onto which the molten material is directed, exacerbates the unbalance. One example is the build-up of a layer of solidified melt on the rotor, so-called “freeze lining”, which may be uneven and may detach in areas giving rise to unbalance. Due to a combination of these factors, the bearings used within existing spinners become worn much more quickly than desired, requiring the spinner to be out of production for maintenance. Thus, there is a significant need to improve the rotor configuration and dynamics to increase the mean time between failures.

It has been found that the vibrations at the drive end (DE) and non-drive end (NDE) of the high speed rotor, in use, are not equal. The applicant's earlier publication EP4028368 discloses a rotor having an identical damper assembly associated with each bearing assembly. Each damper assembly is arranged in an annular ring having an equal stiffness. However, it has been found that unwanted vibrations can be created if there is such an unbalance between the DE and NDE of the rotor. Unwanted vibrations cause significant wear on the bearings seated at each end of the rotors and on the dampers placed between the rotor housing and the spinner body.

The present invention sets out to provide an improved rotor for a fiberising apparatus, which addresses the above-described problems associated with unbalances and unwanted vibrations

According to the present invention there is provided a rotor for a fiberising apparatus comprising
a rotor housing;
a drive end and a non-drive end bearing assembly, wherein each bearing assembly comprises a plurality of ball bearings, each seated in a respective bearing seat;
a substantially horizontal shaft rotatably mounted between the drive end bearing assembly and the non-drive end bearing assembly;
a drive end damper ring connected to the drive end bearing assembly and a non-drive end damper ring connected to the non-drive end bearing assembly, wherein: each damper ring comprises one or more resilient dampers arranged in an annular ring, wherein the or each resilient damper is connected at a first end to the bearing seat and connected at a second end to the inner wall of the rotor housing;
characterised in that the stiffness of the drive end damper ring is greater than the stiffness of the non-drive end damper ring.

Preferably, the stiffness of the or each resilient damper in the drive end damper ring is greater than the stiffness of the or each resilient damper in the non-drive end damper ring.

Preferably, the overall stiffness of the drive end damper ring is greater than the overall stiffness of the non-drive end damper ring.

Preferably, the drive end damper ring comprises a plurality of resilient dampers each having an identical stiffness.

Preferably, the non-drive end damper ring comprises a plurality of resilient dampers each having an identical stiffness.

It has been found that a damper ring at the drive end (DE) bearing assembly having greater stiffness compared to the non-drive end (NDE) bearing assembly offers significant advantages to a high speed rotor. The present invention reduces any unbalance when compared to using an identical damper ring at both the drive end and the non-drive end bearing assembly. The present invention allows for balancing of the rotor to reduce the wear on the bearings. It has been found that there is effectively a heavier load at the non-drive end than the effectively lighter load at the drive end. A stiffer, i.e., a harder, damper ring at the drive end bearing assembly controls any vibrations that may result from the unbalance. Thus, the rotor is able to withstand the high speeds and significant loads exerted upon the rotor assembly. Accordingly, the rotor of the present invention extends the lifetime of the dampers and, thereby, reduces any down time required for repair and maintenance.

It is understood that the stiffness of the damper ring is calculated based on measurements of the spring constant (K) in three dimensions of the resilient dampers arranged in the damper ring.

Preferably, the stiffness (K_{DE}) of the drive end damper ring is greater than the stiffness (K_{NDE}) of the non-drive end damper ring by a factor in the range of 3 to 7.

Preferably, the stiffness (K_{DE}) of the drive end damper ring is greater than the stiffness (K_{NDE}) of the non-drive end damper ring K_{NDE} by a factor of about 5.

Preferably, the stiffness (K_{NDE}) of the non-drive end damper ring is between about 5*10⁵ N/m and 10⁶ N/m.

Optionally, the stiffness (K_{NDE}) of the non-drive end damper ring is less than or equal to about 10⁶ N/m.

Preferably, the stiffness (K_{DE}) of the drive end damper ring is between about 15*10⁵ N/m and 7*10⁶ N/m.

Preferably, the stiffness (K_{DE}) of the drive end damper ring is about 5*10⁶ N/m.

Preferably, the or each resilient damper in the drive end damper ring is formed from a material which has a Shore A hardness in the range of 75 to 100.

Preferably, the or each resilient damper in the drive end damper ring is formed from a material which has a Shore A hardness of 80 to 85.

Preferably, the or each resilient damper in the non-drive end damper ring is formed from a material which has a Shore A hardness in the range of 45 to 65.

Preferably, the or each resilient damper in the non-drive end damper ring is formed from a material which has a Shore A hardness of 55.

The present invention solves the problem of any unwanted vibrations and any unbalance between the drive end and the non-drive end of the rotor, whilst recognising that if the damper ring is too stiff this will risk damaging the bearings. It has been found that if the damper ring stiffness is too low, this will cause the vibrations and, in use, the wheel will hang to a greater extent than is desirable. Whilst, if the damper ring stiffness is too high, the lifetime of the bearings will be reduced. Furthermore, if the damper ring stiffness is too low this can cause damage because the rotor moves more than is desirable and there is significant movement in relation to the coupling to a motor or contact between parts. By optimising the damper ring stiffness at both the non-drive end (NDE) and the drive end (DE), the vibration and unbalances in the rotor can be accurately compensated for to reduce the overall wear on the bearings and increase the lifetime of the rotor/s. Furthermore, the stiffness of the damper rings of the present invention is carefully balanced so that the differential between the stiffness at the drive end and non-drive end is optimised.

Preferably, the height of the or each resilient damper is between about 20 mm and about 30 mm; more preferably, the height of each damper is between about 22 mm and about 27 mm; most preferably, the height of each damper is about 25 mm.

Preferably, the outer face of each damper has a diameter of between about 25 mm and about 29 mm; more preferably, the outer face of each damper has a diameter of between about 26 mm and about 28 mm; most preferably, the outer face of each damper has a diameter of about 27 mm.

It is understood that the “outer” face of the damper refers to the face adjacent to the rotor housing.

Preferably, the inner face of each damper has a diameter of between about 18 mm and about 22 mm; more preferably, the inner face of each damper has a diameter of between about 19 mm and about 21 mm; most preferably, the inner face of each damper has a diameter of about 20 mm.

It is understood that the “inner” face of the damper refers to the face adjacent to the bearing seat.

In addition to the balancing of the drive end and non drive end using different damper ring stiffness it has been shown that a greater volume of softer rubber performs more effectively than a lesser volume of stiffer rubber. The damper ring stiffness of the present invention has been optimised to a working rotation speed of between about 4000 RPM and 13000 RPM. It is understood that the bearing lifetime is how long a user can expect the ball bearing to last under standard operating conditions, which has been found to depend on the amount of bearing load and is calculated in number of revolutions so that the time per revolution and the percentage of time the bearing is in continuous revolution are used to determine bearing life.

Preferably, the or each resilient damper is a rubber damper.

Optionally, the or each resilient damper is a silicone damper.

Preferably, the or each resilient damper is a neoprene rubber damper.

Preferably, the or each resilient damper is releasably connected to the bearing seat and is releasably connected to an inner wall of the rotor housing.

The inner wall of the rotor housing is understood to be the wall facing towards the coupling means of the drive end bearing assembly and the non-drive end bearing assembly.

The releasable connection of the or each resilient damper to the bearing seat and to the inner wall of the rotor housing is such that the or each resilient damper works in compression and tension to offer a significant increase in the mean time before failure of the bearings. This feature also reduces the likelihood of any problems with the natural frequency of the dampers and any loss of effect that can occur when using springs; for example, if a spring loses contact at one end.

Preferably, each resilient damper is cylindrical, conical or a frustum such as a frustoconical shape.

A cylindrical shape, conical shape or a frustrum, such as a frustoconical, have an improved capacity to withstand both static and dynamic loads at the bearing suspensions.

Preferably, wherein each resilient damper is conical or a frustum such as a frustoconical shaped, the damper has a greater diameter at the inner wall of the rotor housing and a lesser diameter at the bearing seat.

Preferably, there is provided a plurality of resilient dampers in the drive end bearing assembly.

Preferably, there is provided a plurality of resilient dampers in the non-drive end bearing assembly.

A plurality of resilient dampers arranged concentrically balances the load and minimises the internal wear of the bearings by providing improved absorption of vibrations generated by the high speed/high acceleration and any unbalances of the spinning rotor, even if minimal.

Preferably, each resilient damper is rotationally symmetrical.

Ease of mounting of the dampers at a bearing seat of a spinner is improved by the dampers having rotational symmetry; that is, by the damper being rotationally symmetrical about their central axis.

Preferably, each damper comprises a threaded screw for releasable connection to the bearing seat and/or each damper comprises a threaded aperture for releasable connection with a screw through the rotor housing.

Preferably, the rotor housing further comprises at least one threaded screw receivable by a threaded aperture in a damper.

The releasable connection of each damper allows for fast and convenient replacement to improve the efficiency of maintenance of the rotor.

Preferably, the rotor housing has a greater wall thickness at the base of the rotor housing than at the upper surface of the rotor housing.

Preferably, the rotor housing has an increased base wall thickness and decreased upper wall thickness in that the base wall thickness is increased between about 2 mm and about 3 mm and the upper wall thickness of the rotor housing is reduced correspondingly; more preferably, the rotor housing has a base wall thickness that is increased between about 2.2 mm and about 2.7 mm and the upper wall thickness of the rotor housing is reduced correspondingly; most preferably, the rotor housing has a base wall thickness that is increased by about 2.5 mm and an upper wall thickness of the rotor housing that is reduced by about 2.5 mm when compared with a standard wall thickness of the rotor housing.

Preferably, the bearing seat is substantially cylindrical, and the rotor housing is substantially cylindrical, wherein the central axis of the bearing seat is offset from the central axis of the rotor housing.

It is understood that “base wall thickness” refers to the thickness of the rotor housing wall in the area closest to the floor in use. The “upper wall thickness” refers to the thickness of the rotor housing wall at the area furthest from the floor in use.

Preferably, the internal profile of the rotor housing is asymmetric.

It has been found that a greater wall thickness at the base of the rotor housing effectively lifts the wheel to compensate for the overhanging effect, i.e., the effect of gravity on the overhanging wheel, and so reduces potential problems in the spinning process by adjusting the rotor to the desired position. For example, potential problems arise when various auxiliary installations are not aligned with the wheel, e.g., air nozzles or binder supply nozzles.

Preferably, the clearance between the annular bearing seat and the inner surface of the rotor housing is between about 10 mm and about 18 mm; more preferably, between about 12 mm and about 16 mm; most preferably, about 14 mm.

It has been found that by increasing the clearance between the annular bearing seat and the inner face of the rotor housing, the risk of failure due to debris/slag becoming lodged between the annular bearing seat and the inner surface of the rotor housing is significantly reduced. If debris/slag becomes lodged within the clearance, the suspension can no longer move, and the bearing is damaged. The arrangement of the present invention ensures that this cause of failure is eliminated.

Preferably, the rotor comprises between about 10 and about 24 frustoconical dampers arranged annularly. More preferably, the rotor comprises between about 10 and about 24 frustoconical dampers arranged annularly equidistant from each other around a substantially annular bearing assembly.

The volume of rubber in the “soft” suspension of the present invention and the number of dampers has been carefully selected to withstand wear. For all rotor sizes, an optimum number of rubber dampers is used to provide the required lifetime whilst ensuring that unbalances are compensated for.

Preferably, the or each ball bearing is an angular contact ball bearing.

Preferably, the or each ball bearing is a hybrid angular ball bearing having a steel lining and balls made of ceramic material.

Preferably, the inner diameter of the or each ball bearing is between about 40 mm and about 80 mm; more preferably, the diameter of the or each ball bearing is between about 60 mm and about 70 mm; most preferably, the diameter of the or each ball bearing is about 70 mm.

A small diameter increases lifetime of the bearing, but too small a diameter is problematic in view of fitting the wheel onto the shaft (contact faces on shaft will become too small).

Preferably, the bearing assembly comprises two angular contact ball bearings provided spaced apart.

Preferably, the distance between the two angular contact bearings is between about 10 mm to about 30 mm; more preferably, the distance between the two angular contact bearings is between about 15 mm to about 25 mm; most preferably, the distance between the two angular contact bearings is about 20 mm.

Preferably, the contact angle of each angular contact ball bearing is about 15°.

Preferably, the bearing assembly comprises two angular ball bearings each spaced apart by an inner axial spacer ring and an outer axial spacer ring.

It has been found that there is a significant temperature difference between the shaft of the rotor and the bearing seat when the rotor is in use. When the shaft is cold it will have a lesser diameter and a greater pressure angle with respect to the pressure direction on the bearing. When the shaft is hot it will expand to a greater diameter and the pressure angle on the bearing will reduce. The configuration of the bearing assembly to comprise an inner axial spacer ring and an outer axial spacer ring allows for the expected temperature difference so that the ball bearings do not “rattle” or have too much pressure exerted on them but are in the desired position.

Preferably, the width of the outer spacer ring is less than the width of the inner spacer ring.

Preferably, the width of the outer spacer ring is between about 10 μm and about 70 μm less than the width of the inner spacer ring; more preferably, the width of the outer spacer ring is about 61 μm less than the width of the inner spacer ring.

Preferably, the or each spacer ring is steel.

Preferably, the shaft is substantially cylindrical.

Preferably, the outer cross-sectional diameter of the shaft is between about 80 mm and about 120 mm; more preferably, about 100 mm.

The diameter of the shaft of the present invention is a compromise because increasing diameter will make the shaft stiffer, thereby positively influencing the dynamic behaviour of the system, but negatively influencing the weight and cost. A small diameter shaft also increases the risk of undesirable dynamic vibrations. If the diameter is chosen at 30 mm for the present system, the flexibility of the shaft will mean that the shaft rotates at critical speed at 12,000 RPM and bend critically.

Preferably, the relationship between the shaft diameter (D_{shaft}) and the shaft length (L_{shaft}) is defined as: D_{shaft}(L_{shaft})>0.12*L_{shaft}−32 mm for a range of shaft lengths between about 101 mm and about 1325 mm and for a range of shaft diameters greater than or equal to 20 mm and for a seat stiffness (damper ring stiffness) of less than or equal to 3*10⁶ N/m.

By increasing the cross-sectional diameter, also referred to as “thickness” of the shaft the vibrations generated by the shaft when rotating are significantly reduced. By reducing vibration, the wear on moving parts and unbalance of the device is reduced, such that the mean time between failure is increased.

Preferably, the length of the shaft between a centre-point of the first bearing assembly and a centre-point of the second bearing assembly is between about 530 mm and about 590 mm; more preferably, about 590 mm.

Preferably, the total length of the shaft is between about 800 mm and about 1200 mm; preferably about 1000 mm.

Preferably, the shaft is steel.

Preferably, the weight of the or each bearing seat is between about 1.5 kg and about 3.5 kg; preferably, between about 2 kg and about 3 kg; more preferably, the weight of each bearing seat is about 3 kg.

It has been found that reducing the mass of the bearing seat reduces the vibrations and so the wear on the bearings such that the lifetime and mean time between failure of the bearings is increased.

Preferably, the bearing seat is an annular ring having a plurality of substantially cylindrical recesses each for receiving a damper, preferably a frustoconical damper. Optionally, the bearing seat is an annular ring having a plurality of truncated cylindrical recesses each for receiving a damper, preferably, a frustoconical damper.

By minimising the weight of the bearing seat, the load on the bearings is reduced. The shape and configuration of the bearing seat securely holds the dampers, whilst allowing for easy removal of the dampers for maintenance and to access the ball bearings.

Preferably, the maximum rotational speed of the rotor is about 13,000 RPM.

Preferably, the rotational speed of the rotor is between about 6,000 RPM and about 13,000 RPM.

Preferably, the rotor further comprises a cooling system.

Preferably, the cooling system comprises at least one fluid inlet and at least one fluid outlet with at least one channel therebetween passing through at least one bearing seat of the rotor.

The cooling system of the present invention allows the temperature change (ΔT) between bearing seats to be substantially constant. Thus, the temperature of the ball bearings can be reduced. The cooling system also ensures that the temperature of the rubber damper/s is kept low, so that the maximum temperature is maintained at about 50-60° C.

Preferably, the rotor is water-cooled.

Preferably, the rotor further comprises an air-flow system.

Preferably, the rotor further comprises an airflow purging system.

The present invention operates within a harsh environment and the bearings are relatively exposed because of the open housing design. It has been found that air flow through the system can be used to remove unwanted debris and contaminants from around the or each bearing to reduce uneven wearing of the bearings and optimise performance of the rotor.

Preferably, each rotor is provided with a drive means.

Preferably, the rotor housing is substantially cylindrical.

More preferably, the rotor housing is substantially cylindrical comprising two mating parts. Preferably the two mating parts are substantially symmetrical. More preferably, the rotor housing comprises two semi-cylindrical shells. Preferably, the two semi-cylindrical shells mate with each other to form the substantially cylindrical housing. Preferably, each shell has the shape of a longitudinal half of a cylinder.

By providing an open housing, which can be easily and conveniently opened, the time and complexity of maintenance is reduced so that the “down time” when the device is not operational for maintenance reasons is also reduced.

In a further aspect, the invention provides a fiberising apparatus comprising a set of at least two rotors as described herein, each rotor mounted for rotation about a different substantially horizontal axis and arranged such that, when the rotors are rotating, melt poured on to the periphery of the first rotor in the set is thrown successively onto the periphery of each of the subsequent rotors and fibres are thrown off from the rotors.

Preferably, the fiberising apparatus comprises a set of four rotors as described herein.

Preferably, the fiberising apparatus comprises a set of four rotors wherein two of the rotors are as described herein.

Preferably, each subsequent rotor is sized such that it can give greater acceleration than the preceding rotor in the set.

Preferably, each rotor is attached to a wheel.

Preferably, a first rotor is attached to a first wheel having a diameter of about 184 mm, wherein the first wheel is rotatable at between about 5,000 RPM and about 6,000 RPM with an acceleration field of between about 25 km/s² and about 36 km/s².

Preferably, a second rotor is attached to a second wheel having a diameter of about 234 mm, wherein the second wheel is rotatable at between about 6,000 RPM and about 13,000 RPM with an acceleration field of between about 46 km/s² and about 217 km/s².

Preferably, a third rotor is attached to a third wheel having a diameter of about 314 mm, wherein the third wheel is rotatable at between about 6,000 RPM and about 13,000 RPM with an acceleration field of between about 62 km/s² and about 291 km/s².

Preferably, a fourth rotor is attached to a fourth wheel having a diameter of about 332 mm, wherein the fourth wheel is rotatable at between about 6,000 RPM and about 13,000 RPM with an acceleration field of between about 65 km/s² and about 308 km/s².

Preferably, the fiberising apparatus further comprises a collector; more preferably, comprising a chamber to collect the fibres from the or each rotor and carry them away from the set of rotors.

Preferably, the fiberising apparatus further comprises at least one temperature sensor; optionally, comprising a pyrometer.

In a further aspect, the present invention provides a method of manufacture of man-made vitreous fibres (MMVF) comprising:
providing a fiberising apparatus comprising a set of at least two rotors as described herein, each mounted for rotation about a different substantially horizontal axis, wherein each rotor has a drive means;
rotating the rotors;
providing a mineral melt for formation of man-made vitreous fibres (MMVF) wherein the melt is poured on to the periphery of the first rotor;
collecting the fibres formed.

For the purposes of clarity and a concise description, features are described herein as part of the same or separate embodiments; however, it will be appreciated that the scope of the invention may include embodiments having combinations of all or some of the features described.

The invention will now be described by way of example with reference to the accompanying drawings, in which:

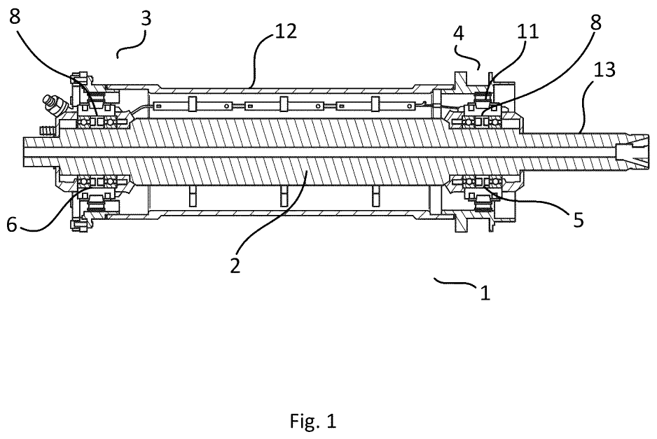

FIG. 1 is a longitudinal cross-sectional view of a rotor according to the present invention;

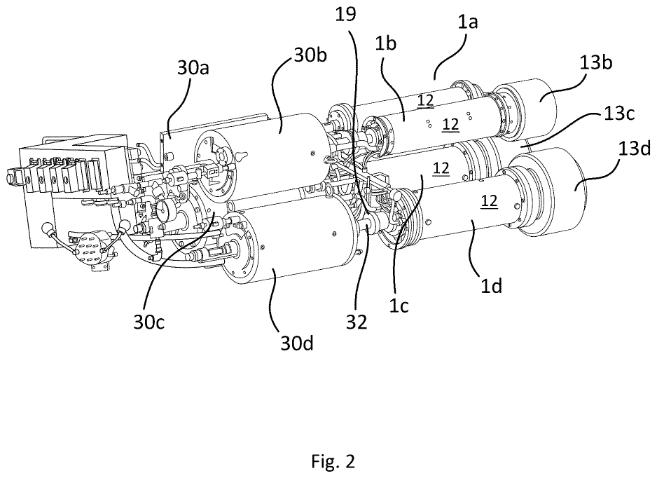

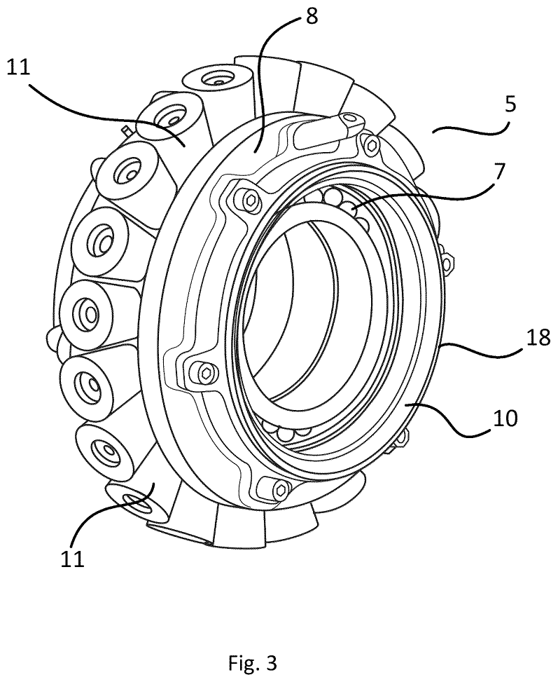

FIG. 2 is a perspective view of a right position spinner comprising four rotors in accordance with the present invention, shown without the spinner housing;

FIG. 3 is a perspective view of a bearing assembly at the non-drive end (NDE) of the rotor of FIG. 1;

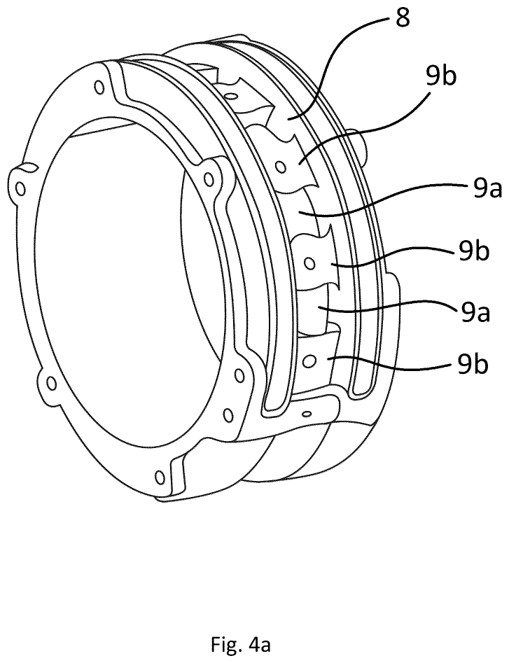

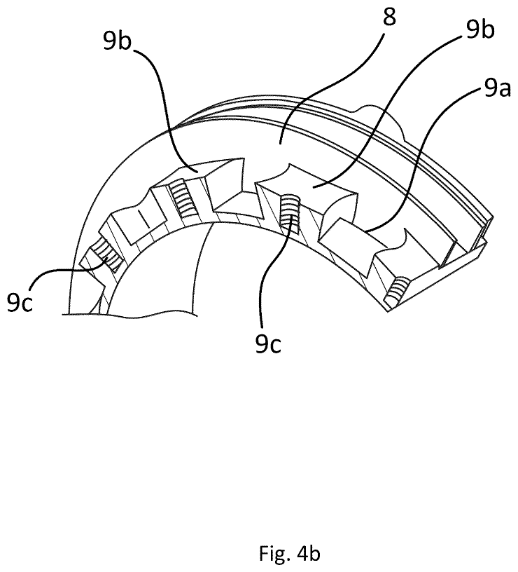

FIG. 4a is a perspective view of the bearing seat of the bearing assembly of the rotor in accordance with the present invention without the dampers shown;

FIG. 4b is a perspective view of a section of the bearing seat shown in FIG. 4a;

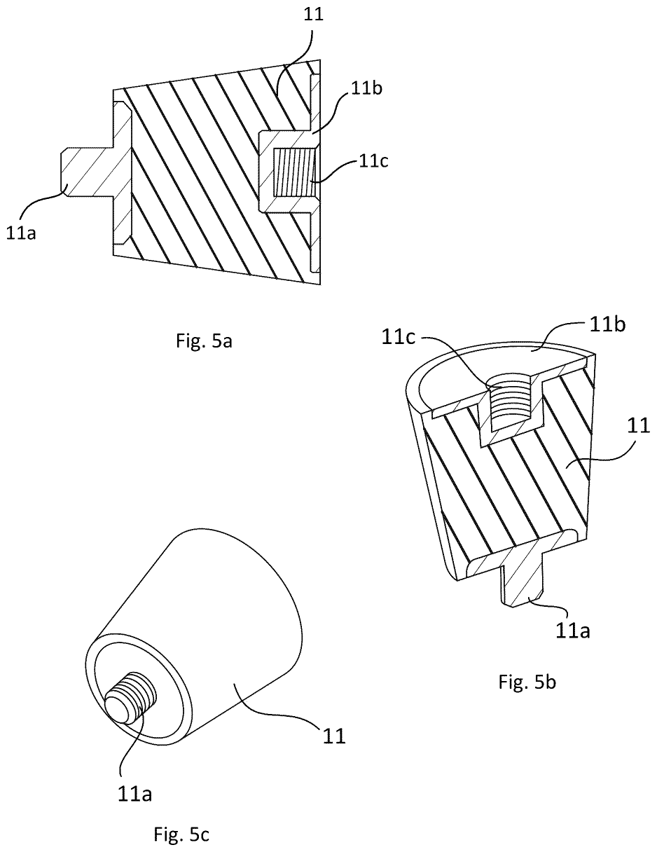

FIG. 5a is a cross-sectional view through a frustoconical damper shown in the bearing assembly of FIG. 3;

FIG. 5b is a perspective view of a cross-section of the frustoconical damper of FIG. 5a;

FIG. 5c is a perspective view of the damper of FIGS. 5a and 5b;

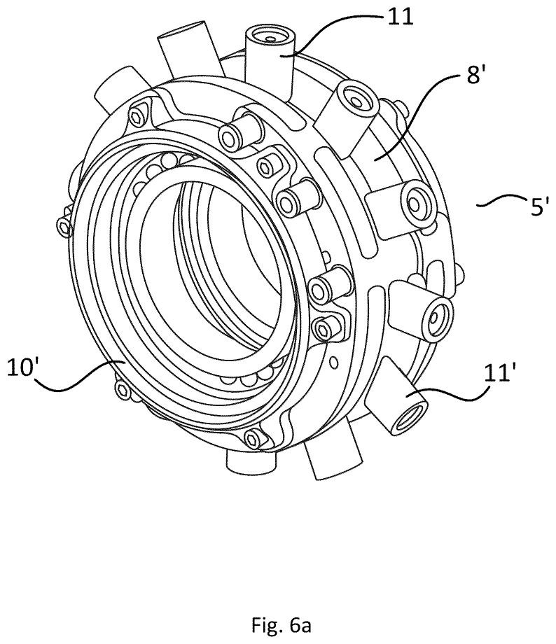

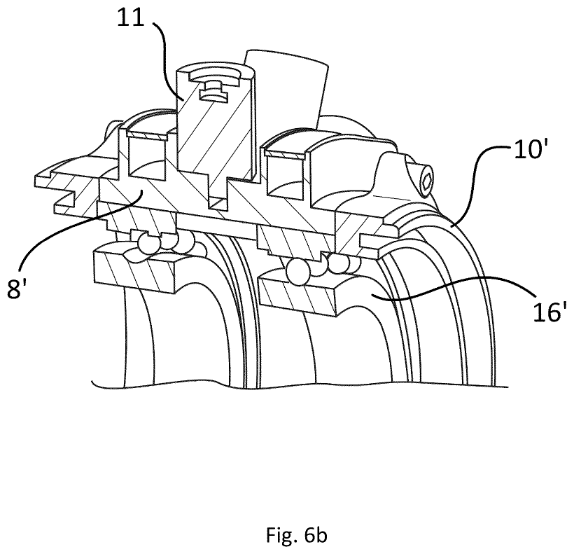

FIG. 6a is a perspective view of an alternative embodiment of a bearing assembly at the non-drive end (NDE) of a rotor in accordance with the present invention;

FIG. 6b is a perspective view of a section of the bearing seat shown in FIG. 6a;

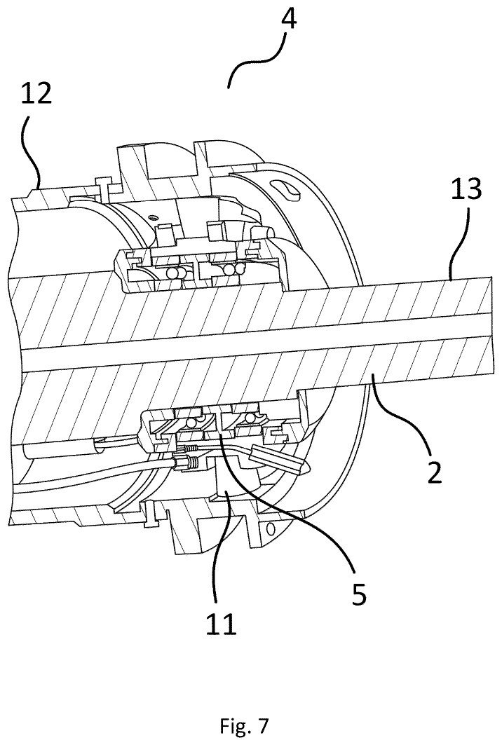

FIG. 7 is a cross-sectional view through a bearing assembly at the non-drive end (NDE) of the rotor showing the greater clearance between the bearing assembly and the rotor housing;

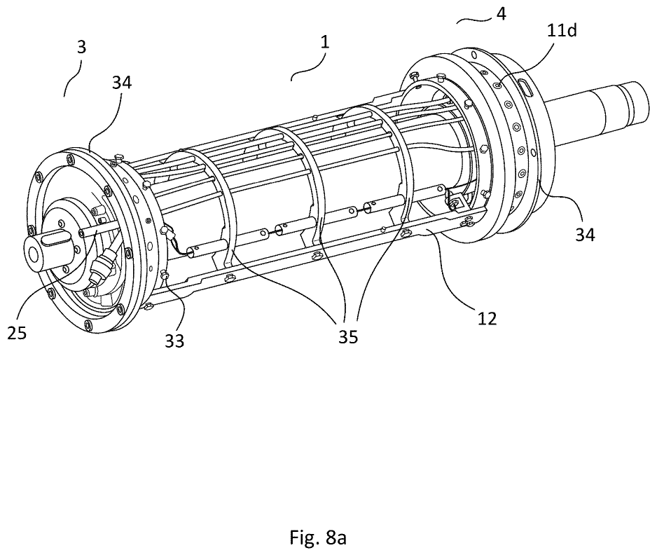

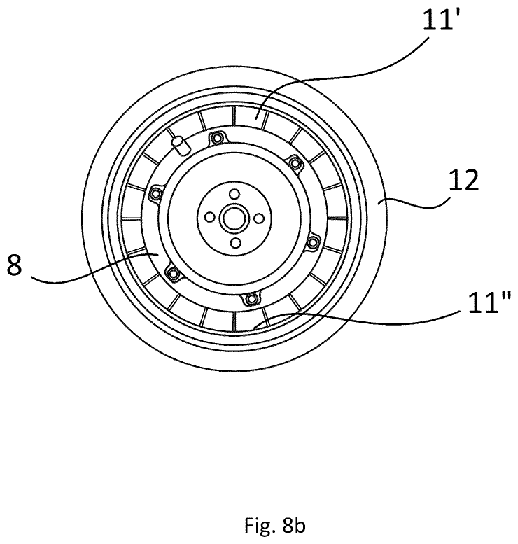

FIG. 8a is a perspective view of the rotor of the present invention showing half of the rotor housing removed;

FIG. 8b is a plan view of the NDE of the rotor housing, bearing seat and dampers of the present invention;

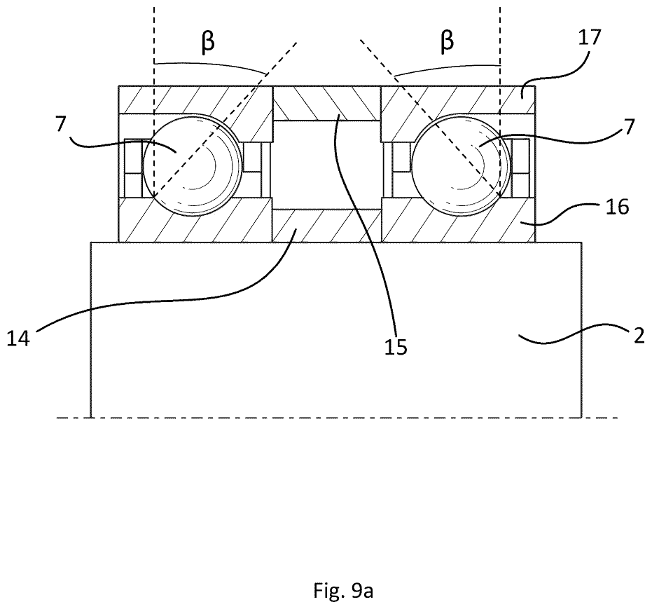

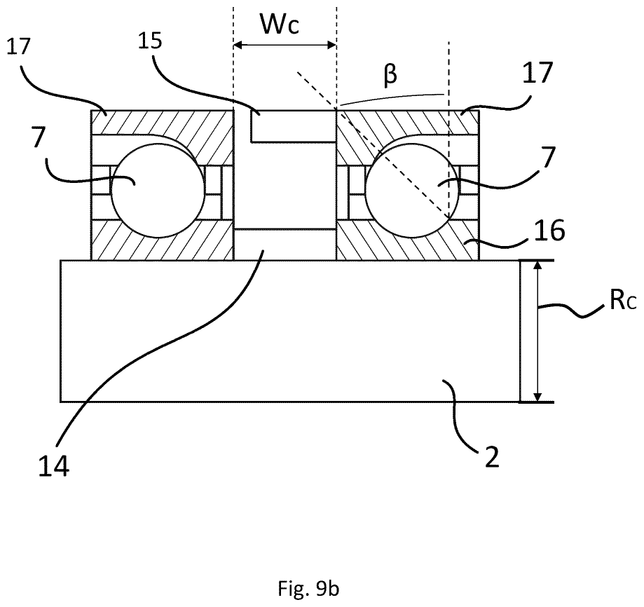

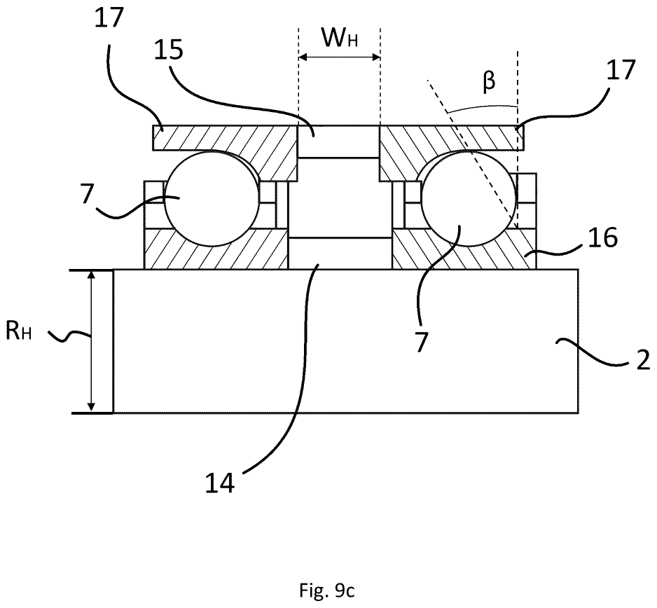

FIGS. 9a, 9b and 9c are schematic cross-sectional views (not to scale) through a pair of angular contact ball bearings in the rotor of the present invention, exemplifying the preferred reduction in bearing preloads due to temperature differences, wherein FIG. 9b shows the shaft when cold and FIG. 9c shows the shaft when hot;

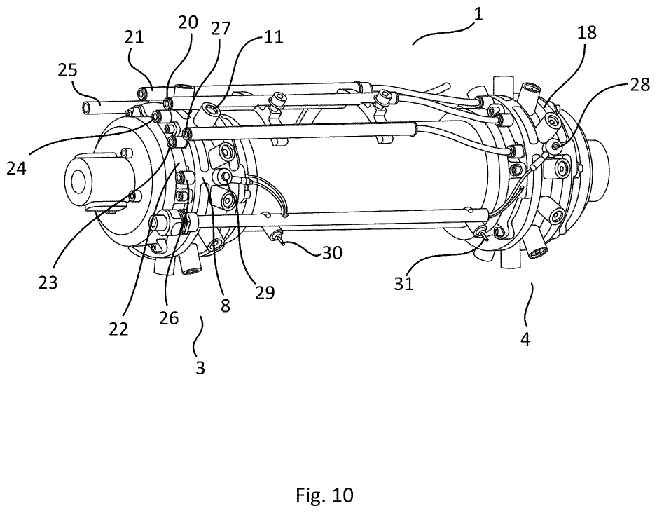

FIG. 10 is an external perspective view of the rotor of the present invention showing the cooling and air purging systems;

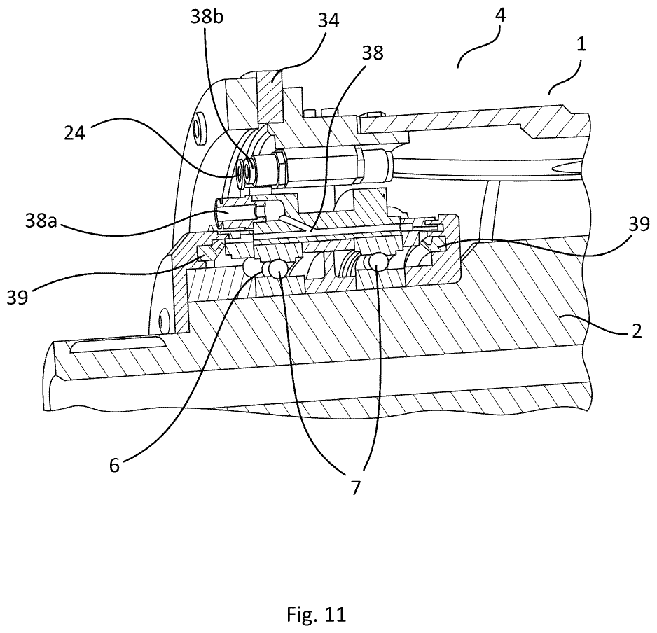

FIG. 11 is a cross-sectional view of the DE bearing seat showing a grease labyrinth;

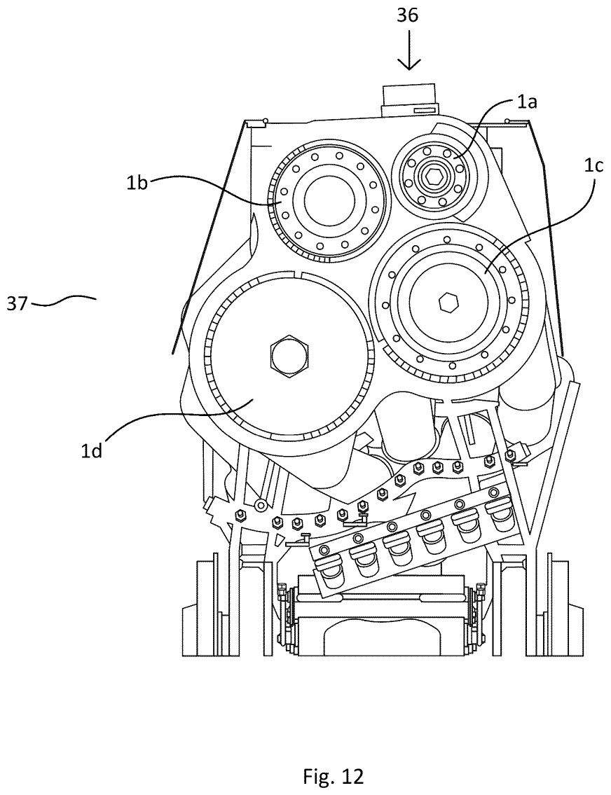

FIG. 12 is a front view of the right position spinner of the present invention showing all four rotors with mounted wheels;

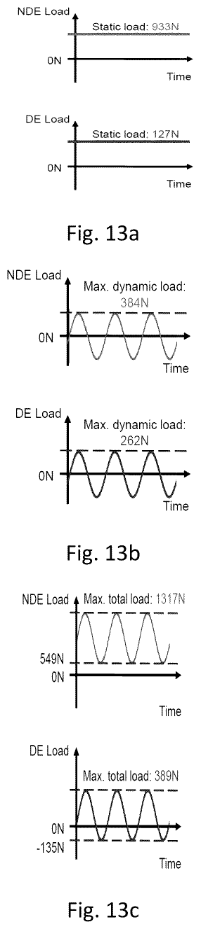

FIG. 13a, FIG. 13b and FIG. 13c show the static, dynamic and total loads at the non-drive end (NDE) and drive end (DE) of a prior art rotor using an identical damper ring at the non-drive end (NDE) and drive end (DE), for a rotation speed of 13000 Rpm when there is a 40 g unbalance;

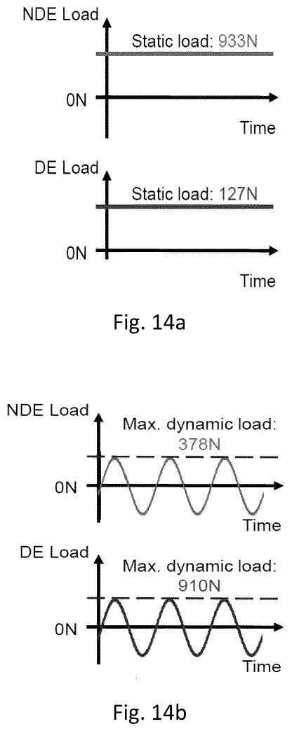

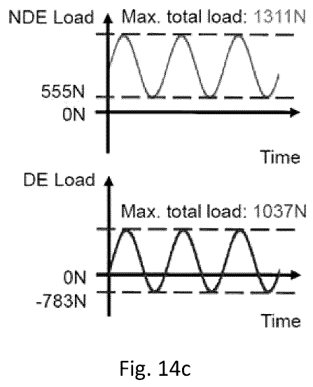

FIG. 14a, FIG. 14b and FIG. 14c show the static, dynamic and total loads at the non-drive end (NDE) and drive end (DE) of the rotor of the present invention, with a drive end (DE) damper ring having a greater stiffness than the non-drive end (NDE) damper ring, when there is a 40 g unbalance; and

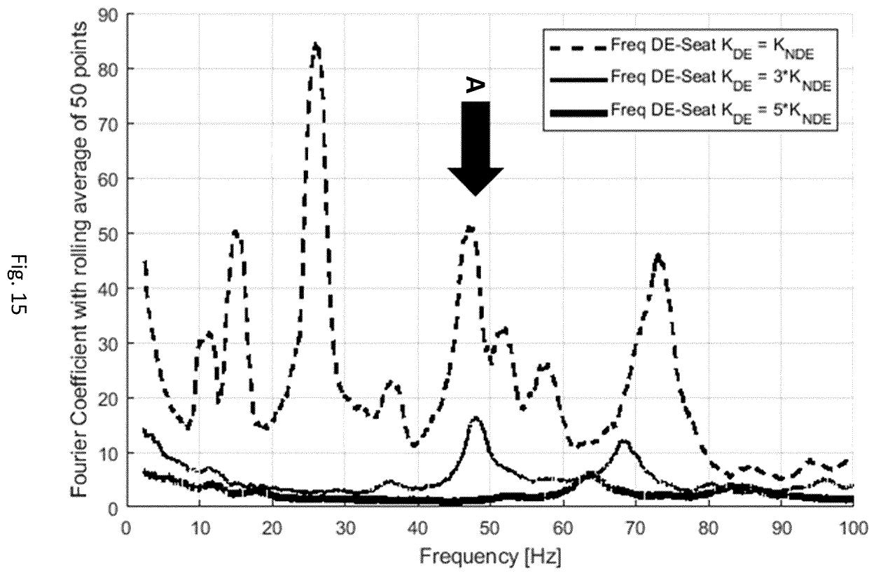

FIG. 15 shows FFT-analysis for comparison of different damper ring stiffnesses, wherein the frequency subdomains for the drive end (DE) seat displacements are shown wherein i) the stiffness of the damper ring at the drive end (K_{DE}) is equal to the stiffness of the damper ring at the non-drive end (K_{NDE}); ii) the stiffness of the damper ring at the drive end (K_{DE}) is three times greater than the stiffness of the damper ring at the non-drive end (K_{NDE}); and iii) the stiffness of the damper ring at the drive end (K_{DE}) is five times greater than the stiffness of the damper ring at the non-drive end (K_{NDE}).

Referring to FIG. 1, a longitudinal cross-section of the rotor 1 is shown, with the shaft 2 longitudinally positioned between a drive end (DE) 3 and non-drive end (NDE) 4 of the rotor 1 to be substantially horizontal. The shaft 2 is a hollow cylindrical steel shaft with an outer diameter of about 100 mm and a bearing seat diameter of about 70 mm. In alternative embodiments, the shaft outer diameter is between about 100 mm and about 120 mm and the bearing seat diameter is between about 50 mm and about 100 mm. The length of the shaft 2 between a centre-point of the bearing at the DE 3 and a centre-point of the bearing at the NDE 4 is between about 530 mm and 590 mm. For the embodiment shown, the length of the shaft 2 is about 590 mm. At the NDE 4 the shaft 2 “over-hangs” beyond the first bearing assembly 5 and the total length of the shaft 2 is about 955 mm. A second bearing assembly 6 is positioned at the DE 3. The bearing assembly 5, 6 for both the NDE 4 and the DE 3 are identical (except for minor details like cooling water supply to the wheel), but the NDE 4 bearing assembly 5 is described in more detail with respect to FIGS. 3 to 5. The first and second bearing assembly 5, 6 are each placed adjacent to a “soft” suspension, with the respective first and second soft suspensions acting independently of each other. The NDE 4 may comprise more than one bearing assembly 5, which will increase bearing lifetime as the static load on each bearing assembly 5 is reduced.

Referring to FIG. 2, a perspective view of the four rotors of a right position spinner is shown without the spinner body; a first rotor 1a, a second rotor 1b, a third rotor 1c and a fourth rotor 1d, are shown. Right position refers to the position of fourth rotor 1d to the right. A variant (not shown) is a left position spinner, which is a mirror image of the right position spinner shown in FIG. 2, but with the fourth rotor 1d positioned to the left. The first rotor 1a has a maximum speed of 6000 RPM and is connected to a first motor 30a. The second rotor 1b has a maximum speed range of between 6000-13000 RPM and is connected to a second motor 30b. The third rotor 1c has a maximum speed range of between 6000-13000 RPM and is connected to a third motor 30c. The fourth rotor 1d has a maximum speed range of between 6000-13000 RPM and is connected to a fourth motor 30d. The wheels 13b, 13c, 13d attached respectively to the second, third and fourth rotors are shown. Each motor 30a, 30b, 30c, 30d and the respective motor shaft are fixed at the spinner body. The rotor shaft 2, shown in FIG. 1, is mounted flexibly inside the rotor housing 12, which is also fixed. A flexible lamella coupling 32 connects the shafts of each motor drive end and drive end of each rotor and allows for some radial misalignment. However, the maximal allowable radial misalignment of the present coupling is 1.3 mm. Hence the coupling puts a restriction on the allowable displacement of the shaft 2 at the DE 3. With reference to FIG. 8a, there are further connections between the motors 30a, 30b, 30c, 30d and the rotors 1a, 1b, 1c, 1d to power and cool the spinner.

With reference to FIGS. 3, 4a and 4b the bearing assembly 5 is shown in more detail and comprises two ball bearings 7 held within an annular bearing seat 8. The bearing seat 8 has a stainless-steel body shown in FIG. 4a and FIG. 4b having a plurality of recesses 9a equally spaced around its outer surface with damper seats 9b equally spaced therebetween. Referring to FIG. 4b, each damper seat 9b has a threaded hole 9c into which a damper 11 is secured. As shown in FIG. 4b, the recesses 9a are truncated cylindrical recesses. The bearing seat 8 has a very low mass of 3 kg with the minimum of material to support the components held by the bearing seat 8. The bearing seat 8 also comprises an aluminium labyrinth ring 10 to reduce the seat mass.

With reference to FIG. 3 and FIG. 4a, each damper seat 9b supports one end of a frustoconical damper 11, which protrudes from the bearing seat 9b and the bearing seat 8. As shown in FIGS. 5a, 5b and 5c, the dampers 11 are frustoconical with a threaded metal screw 11a at a first smaller inner end face or tap end. The inner end face has a diameter of about 20 mm. There is a further metal insert 11b at the second outer end face or hole end, which has a central threaded aperture 11c partially into the rubber damper 11. The outer end face has a diameter of about 27 mm and the length of the damper 11 is about 25 mm. With reference to FIGS. 3 and 4b, the damper 11 is connected to the bearing seat 8 by a screw connection, whereby the threaded screw 11a of the damper 11 engages a threaded hole 9c in the bearing seat 8. Similarly, the outer end face of the damper 11 is provided with the threaded aperture 11c for engagement with a threaded screw or bolt for connecting the damper 11 to the rotor housing (not shown). The dampers 11 are made of neoprene rubber. The drive end (DE) damper ring is formed from a material which has a Shore A hardness of about 90. The non-drive end damper ring is formed from a material which has a Shore A hardness of 55. The stiffness of the drive end damper ring is greater than the stiffness of the non-drive end damper ring. The stiffness of the drive end damper ring is about five times greater than the stiffness of the non-drive end damper ring. The stiffness (K_{DE}) of the drive end damper ring is between about 15*10⁵ N/m and 7*10⁶ N/m, preferably about 5*10⁶ N/m. The stiffness (K_{NDE}) of the non-drive end damper ring is between about 5*10⁵ N/m and 10⁶ N/m.

In alternative embodiments, the dampers are cylindrical, but in the preferred embodiment shown in FIG. 3, for rotor 4, there are twenty frustoconical dampers 11 spaced equidistant from each other around the bearing seat 8. Each damper 11 does not touch the adjacent damper 11 in the annular arrangement. The embodiment shown in FIG. 3 is for the fourth rotor of a fiberising apparatus having four rotors. In alternative embodiments, as shown in FIG. 6a, the rotor has between about twelve and about twenty-two frustoconical dampers 11′ equidistant from each other.

FIG. 6a and FIG. 6b show an alternative embodiment of the first bearing assembly 5′ and a bearing seat 8′ for the third and fourth rotors having twelve substantially cylindrical dampers 11 spaced equidistant from each other around the bearing seat 8′. As described previously, the stiffness of the drive end damper ring is greater than the stiffness of the non-drive end damper ring. The drive end (DE) damper ring is formed from a material which has a Shore A hardness of about 90. The non-drive end damper ring is formed from a material which has a Shore A hardness of 55. The stiffness of the drive end damper ring is about five times greater than the stiffness of the non-drive end damper ring. The stiffness (K_{DE}) of the drive end damper ring is between about 15*10⁵ N/m and 7*10⁶ N/m, preferably about 5*10⁶ N/m. The stiffness (K_{NDE}) of the non-drive end damper ring is between about 5*10⁵ N/m and 10⁶ N/m. The damper 11 is connected to the bearing seat 8′ by a screw connection, in that a threaded screw of the damper 11 is engaging a threaded hole in the bearing seat 8′. Similarly, the other end of the damper 11 is provided with a threaded aperture for engagement with a bolt for connecting the damper 11 to the rotor housing. The bearing seat 8′ further comprises a ball bearing inner steel ring 16′ and aluminium labyrinth ring 10′, which is used to reduce the seat mass.

Referring to FIGS. 1, 2 and 7, the dampers 11 are positioned between the bearing seat 8 and the rotor housing 12 to form an annular bearing ring. As shown in FIG. 7, the rotor housing 12 of the present invention has a clearance of about 14 mm between the bearing assembly 5 and the inner surface of the housing 12, both at the NDE 4 and the DE (not shown). In use, the rotor 1 would be attached to a high strength steel wheel at a position 13 further along the shaft 2 from the first bearing assembly 5 at the NDE 4. Referring to FIG. 2, the wheel 13a, 13b, 13c, 13d is placed at a first end of the shaft 2 and the opposite end is connected to a high-speed motor 30a, 30b, 30c, 30d by a flexible coupling. There is a relatively narrow space between the wheels 13a, 13b, 13c, 13d. For the fourth rotor example shown in FIG. 1, the wheel is substantially cylindrical with a weight of about 50 kg, a diameter of about 332 mm, an outer wall thickness of about 25 mm and a side wall thickness of around 15 mm. It is understood that the outer wall of the wheel is a curved surface and the side walls are circular and substantially perpendicular to the length of the shaft 2. With reference to FIG. 2; typically, the wheel diameter of wheel 3 is about 314 mm with a mass of about 50 kg. For a preferred embodiment of the fourth rotor, the wheel is about 47 mm from the centre line of the NDE bearing assembly 5 and rotates at between about 6000 RPM and about 13000 RPM. The rotor housing 12 supports the bearings and covers the middle part of the shaft 2. However, for ease of understanding of the invention the wheel is not shown in FIG. 1.

Referring to FIGS. 2 and 8a, each rotor housing 12 comprises two symmetrical mating parts, each of which is a semi-cylindrical shell, such that when the two parts mate a substantially cylindrical housing 12 is formed. Each half of the rotor housing 12 is held to the adjacent half of the housing by screws 33. FIG. 8a also shows the screws 11d holding each damper (not shown) to the rotor housing. The rotor housing 12 further comprises brackets 35 that support pipes and wires. A rubber ring 34 at each end 4, 5 of the rotor housing 12 is used for mounting the rotor 1 in the spinner.

Referring to FIG. 8b, in preferred embodiments, the rotor housing 12 has a greater wall thickness of about 5 mm at the base of the housing 12 compared to the upper wall thickness of the rotor housing 12, which effectively lifts the wheel to compensate for the overhanging effect. The internal profile of the rotor housing 12 is asymmetric. Referring to FIG. 8b, the dampers 11′ in the top part of the NDE 4 are stretched by about 2.5 mm. The dampers 11″ in the bottom part of the NDE 4 are compressed by about 2.5 mm. The offset arrangement of the central axis of the annular mounting ring/bearing seat 8 with respect to the central axis of the annular rotor housing 12 counteracts the effect of gravity on the suspension of the bearings 7, shaft 2 and wheel 13 in the rotor housing 12 so that the centre of gravity of the rotor 1 is in the desired position.

With reference to FIGS. 3 and 6b, the inner surface of each annular bearing seat 8 supports two hybrid ball bearings 7, which are lifetime lubricated super precision hybrid angular contact ball bearings 7 that have been selected to achieve the desired speed and lifetime before failure. The two bearings 7 at each of the DE 3 and NDE 4 are fitted close together with little space between them at each end of the rotor 1.

Referring to FIGS. 9a, 9b and 9c, the bearings are ceramic ball bearings 7 between two steel bearing rings 16, 17. The bearings 7 have been selected to withstand loads of up to 1400 N. The dynamic load unbalance at the wheel of rotor 4 was determined to be about 560 g·cm and the configuration of the bearing seats and the damper suspensions was optimised to compensate for this unbalance. The angular contact ball bearings 7 have a diameter of about 70 mm, but in alternative embodiments the bearing diameter is any of 60 mm, 65 mm, 70 mm or 75 mm.

In the embodiment of FIGS. 9a, 9b and 9c the ball bearing 7 has a diameter of 70 mm. Each of the pair of ball bearings 7 are axially spaced apart by an inner spacer ring 14 between the rotating inner surfaces of the ball bearings 7 adjacent to the shaft 2 and an outer spacer ring 15 between the rotating inner surfaces of the ball bearings 7 furthest from the shaft 2. The ball bearings 7 are held between a ball bearing inner steel ring 16 mounted on the steel shaft 2 and a ball bearing outer steel ring 17. The angular contact ball bearings 7 each have an angular contact (pressure) angle β, which is symmetrical about the centre line between the ball bearings 7. The contact angle β is the pressure direction during rotation. The contact angle 3 will vary depending on the temperature of the steel shaft 2.

Referring to FIG. 9b, the contact angle β will increase if the shaft 2 is colder because the shaft will contract to a smaller diameter. Referring to FIG. 9c, the contact angle β decreases if the shaft 2 is hotter because the shaft will expand to a greater diameter. As shown in FIG. 9b, when the shaft 2 is cold it has a lesser diameter R_{c} and the pressure angle β is greater. The outer spacer ring 15 has a width W_{c} and does not make contact with both the ball bearing inner steel ring 16 and the ball bearing outer steel ring 17 and there is greater scope for movement/rattling of the ball bearings 7. However, as shown in FIG. 9c, when the shaft 2 is hot it has a greater diameter R_{H} and the pressure angle β is less. The increased diameter of the shaft also means that the balls 7 of the bearing push the outer bearing seats 17 towards each other until then are in contact with the outer spacer ring 15. Thus, the bearing assembly 5, 6 has been arranged to reduce the bearing preloads due to the expected temperature difference when the rotor is in use, which is about 10° C.

Referring to FIG. 9b and FIG. 9c, it has been found that it is advantageous that the outer spacer ring 15 is shorter than the inner spacer ring 14. Typically, for a bearing diameter of 70 mm for rotor 3 and 4, the width of the outer spacer ring 15 is about 61 μm less than the inner spacer ring 14. For rotor 2 for a bearing diameter of 70 mm, the width of the outer spacer ring 15 is about 16 μm less than the inner spacer ring 14.

As shown in FIGS. 3 and 10, the annular bearing seat 8 is surrounded by end rings 18.

As shown in FIG. 10, the rotor 1 has a cooling system for both the DE bearing assembly 6 and the NDE bearing assembly 5. An NDE cooling fluid inlet 20 and an NDE cooling fluid outlet 21 are connected by channels through which cooling fluid flows to carry heat away from the NDE 4 of the rotor 1. A DE cooling fluid inlet 23 and DE cooling fluid outlet 24 are also connected by channels to carry heat away from the DE 3 of the rotor 1. A fluid inlet 25 for water cooling of the wheel (not shown) is also provided. In the embodiment shown the cooling fluid is water. It has been shown through testing that the bearing temperatures can all be maintained at about 50° C.

Referring to FIG. 10, the rotor 1 further comprises a DE air purge inlet 26 and an NDE air purge inlet 27. The air purge system flushes contaminants from the rotor 1. The rotor 1 further comprises an accelerometer 28 at the NDE 4 and an accelerometer 29 at the DE 3 and a pyrometer 30 at the DE 3 and a pyrometer 31 at the NDE 4.

Referring to FIGS. 10 and 11, the air purging system flushes contaminants from the rotors when the spinner is in use. The rotor also comprises a water-cooling system with a cooling water outlet 24 to carry heated water away from the bearings 7. It has been found that, when washing the spinner during regular servicing, there is potential for water to contaminate the bearings 6. Thus, the present invention further comprises a grease labyrinth 38, as shown in FIG. 11, to prevent water polluting the bearings 7 during washing of the spinner. FIG. 11 shows the DE 4 bearing assembly 6 comprising a rubber ring 34 for mounting the rotor 1 in a spinner. For the DE 3 shown, there is a DE labyrinth grease inlet 38a and an NDE labyrinth grease inlet 38b. The NDE labyrinth grease inlet 38b carries grease to the NDE 4, which has a similar grease labyrinth. When the rotor is still because the spinner is being serviced, the labyrinth 38 is sealed with grease to prevent water polluting the bearings 7 during washing. Sealing rings 39 prevent labyrinth grease from flowing into the bearings 7, which are lifetime lubricated with their own grease.

Referring to FIG. 12, in use, a fiberising apparatus comprising four rotors 1a, 1b, 1c, 1d is used to manufacture man-made vitreous fibres (MMVF). Each rotor 1a, 1b, 1c, 1d is mounted for rotation about a different substantially horizontal axis and each rotor 1a, 1b, 1c, 1d has a drive means, which may be a single drive means to power all four rotors 1. In a preferred embodiment, a second rotor comprises a suspension ring at the non-drive end bearing assembly having fourteen neoprene rubber dampers and the third and fourth rotor at the non-drive end have a bearing assembly with twenty neoprene rubber dampers. The second rotor comprises twelve neoprene rubber dampers at the drive end bearing assembly and the third and fourth rotors have eighteen neoprene rubber dampers at the drive end bearing assembly.

Each right position rotor 1a, 1b, 1c, 1d has a high-speed motor connected at one end by a flexible coupling and a wheel is placed at the opposing end of the rotor 1a, 1b, 1c, 1d. In the embodiment shown in FIG. 12, rotors 1 and 3 rotate in an anticlockwise direction and rotors 2 and 4 rotate in a clockwise direction. The wheel of the first rotor 1a has a diameter of about 184 mm; the wheel of the second rotor 1b has a diameter of about 234 mm; the wheel of the third rotor 1c has a diameter of about 314 mm and the wheel of the fourth rotor 1d has a diameter of about 332 mm. The space between the outer surface of each mounted wheel varies, with the greatest distance of about 228 mm between the wheels of the first and fourth rotor 1a, 1d and the least distance of about 17 mm between the first and second rotors 1a, 1b.

Referring to FIG. 12, with the rotors 1a, 1b, 1c, 1d rotating a molten mineral melt of stone or rock or a slag or glass melt is poured through an inlet 36 onto the periphery of the wheel of the first rotor 1a to spin the melt and throw off MMVF. The melt is then thrown successively to the wheels of the remaining three rotors 1b, 1c, 1d and fibres are formed and collected each time. Simultaneously, as the melt passes to the wheel of each successive rotor 1a, 1b, 1c, 1d, a high-pressure air flow through the spinner and along the wheel removes fibres from the wheels for collection.

For a typical four rotor fiberising apparatus according to the present invention, wheel 1 produces about 5% of the hourly stone wool production; wheel 2 produces about 25%, wheel 3 produces about 40% and wheel 4 produces about 30%. Manufacture using the rotors of the present invention can continue for around 4000 hours before the ball bearings 7 require replacement, which is a significant increase over known devices. An endurance test comparing a prior art spinner running at max speed (9300 RPM) with a spinner according to the present invention running at 13000 RPM, both operating with an unbalance of 560 g·cm, showed an improvement from 603 hours to more than 4000 hours. Further tests have found a mean time between failure of approximately 15000 hours for a spinner according to the present invention.

Referring to FIGS. 13a, 13b, and 13c, the static, dynamic and total loads at the non-drive end (NDE) and drive end (DE) of a rotor are shown when using an identical damper ring at the non-drive end (NDE) and at the drive end (DE), for a rotation speed of 13000 Rpm and when there is a 40 g unbalance. The results shown are for an equal damper ring stiffness at the non-drive end K_{NDE} and at the drive end K_{DE} of 10⁶ N/m.

Referring to FIG. 13a, the static load at the non-drive end (NDE) is 933 N and at the drive end (DE) is 127 N. Referring to FIG. 13b, the maximum dynamic load at the non-drive end (NDE) is 384 N and at the drive end (DE) is 262 N. Referring to FIG. 13c, the maximum total load at the non-drive end (NDE) is 1317 N and at the drive end (DE) is 389 N.

Referring to FIGS. 14a, 14b, and 14c, the static, dynamic and total loads at the non-drive end (NDE) and drive end (DE) of a rotor are shown when there is a 40 g unbalance. The maximum static, dynamic and total loads are shown over time when using a different damper ring at the non-drive end (NDE) than at the drive end (DE), for a rotation speed of 13000 Rpm. A stiffer damper ring is used at the drive end. The results shown are for damper ring stiffness at the non-drive end (K_{NDE})=10⁶ N/m and damper ring stiffness at the drive end (K_{DE})=5*10⁶ N/m. The damper ring stiffness at the drive end (K_{DE}) is five times greater than the damper ring stiffness at the non-drive end (K_{NDE}).

Referring to FIG. 14a, the static load at the non-drive end (NDE) is 933 N and at the drive end (DE) is 127 N. Referring to FIG. 14b, the maximum dynamic load at the non-drive end (NDE) is 378 N and the maximum dynamic load at the drive end (DE) is 910 N. Referring to FIG. 14c, the maximum total load at the non-drive end (NDE) is 1311 N and the maximum total load at the drive end (DE) is 1037 N. The improvement of the present invention has been shown to mitigate unwanted vibrations by balancing the load at the drive end and non-drive end of the rotor.

Referring to FIG. 15, a comparison of FFT analysis for different damper stiffnesses is shown. 3D simulations of a rotating rotor were used. The rotating rotor, including a coupling, a shaft, bearing seats and a wheel with a weight therein to simulate an unbalance, were placed in the gravity fields. The simulations are shown for an unbalance of 40 grams at a distance of 14 cm from the centre, which gives an unbalance of 560 g*cm. The results set out in FIG. 15 show the frequency subdomains for drive end (DE) seat displacements, with the Fourier coefficient with rolling average of 50 points on the y-axis and frequency (Hz) on the x-axis. The results are shown for three different damper stiffnesses at the drive end (K_{DE}) and at the non-drive end (K_{NDE}) as follows:

$${K}_{DE} = {K}_{NDE} ;$$

$${K}_{DE} = 3 * {K}_{NDE} ;$$

$${K}_{DE} = 5 * {K}_{NDE} .$$

FIG. 15 shows the displacements for each of these damper stiffnesses, each with a speed ramp of 2 seconds, from zero to full speed at 13000 Rpm used as input for the further Fast Fourier analysis, which is performed at the stationary part for the simulation time of 2 seconds to nearly 20 seconds. The FFT analysis converts the time signal to a representation in the frequency domain. A rolling average is performed afterwards at each curve/trace because the time signal can be noisy.

Referring to FIG. 15, a useful comparison can be seen at approximately 50 Hz frequency (A) wherein a relatively high peak is seen for the simulation of equal damper ring stiffness at the drive end and the non-drive end; i.e. when K_{DE}=K_{NDE}. When the stiffness at the drive end is three times greater than at the non-drive end this resonance is reduced; i.e. when K_{DE}=3*K_{NDE}. Furthermore, when the stiffness at the drive end is five times greater than at the non-drive end this resonance is no longer present; i.e. when K_{DE}=5*K_{NDE}. Thus, it can be seen from FIG. 15 that the unbalance and associated vibrations are significantly reduced when the stiffness of the damper ring at the drive end is five times greater than the stiffness of the damper ring at the non-drive end.

Within this specification, the term “about” means plus or minus 20%; more preferably, plus or minus 10%; even more preferably, plus or minus 5%; most preferably, plus or minus 2%.

Within this specification, the term “substantially” means a deviation of plus or minus 20%; more preferably, plus or minus 10%; even more preferably, plus or minus 5%; most preferably, plus or minus 2%.

The above described embodiment has been given by way of example only, and the skilled reader will naturally appreciate that many variations could be made thereto without departing from the scope of the claims.

1. A rotor for a fiberising apparatus comprising
a rotor housing;
a drive end and a non-drive end bearing assembly, wherein each bearing assembly comprises plurality of ball bearings, each seated in a respective bearing seat;
a substantially horizontal shaft rotatably mounted between the drive end bearing assembly and the non-drive end bearing assembly;
a drive end damper ring connected to the drive end bearing assembly and a non-drive end damper ring connected to the non-drive end bearing assembly, wherein: each damper ring comprises one or more resilient dampers arranged in an annular ring, wherein the or each resilient damper is connected at a first end to the bearing seat and connected at a second end to the inner wall of the rotor housing; and wherein the stiffness of the drive end damper ring is greater than the stiffness of the non-drive end damper ring.

2. The rotor according to claim 1, wherein the stiffness of the or each resilient damper in the drive end damper ring is greater than the stiffness of the or each resilient damper in the non-drive end damper ring.

3. The rotor according to claim 1, wherein the drive end damper ring comprises a plurality of resilient dampers each having an identical stiffness and/or the non-drive end damper ring comprises a plurality of resilient dampers each having an identical stiffness.

4. The rotor according to claim 1, wherein the stiffness (K_{DE}) of the drive end damper ring is greater than the stiffness (KNDE) of the non-drive end damper ring by a factor in the range of 3 to 7.

5. The rotor according to claim 1, wherein:
i) the stiffness (KNDE) of the non-drive end damper ring is between about 5*105 N/m and 106 N/m; and/or
ii) the stiffness (K_{DE}) of the drive end damper ring is between about 15*105 N/m and 7*106 N/m; and/or
iii) the stiffness (K_{DE}) of the drive end damper ring is about 5*106 N/m.

6. The rotor according to claim 1, wherein the or each resilient damper in the drive end damper ring is formed from a material which has a Shore A hardness in the range of 75 to 100.

7. The rotor according to claim 1, wherein the or each resilient damper in the non-drive end damper ring is formed from a material which has a Shore A hardness in the range of 45 to 65.

8. The rotor according to claim 1, wherein the plurality of resilient dampers is adapted for a working rotation speed of the rotor of between about 4000 RPM and 13000 RPM.

9. The rotor according to claim 1, wherein each resilient damper is a frustum.

10. The rotor according to claim 1 comprising a plurality of frustoconical resilient dampers wherein each damper has a greater diameter at the damper face adjacent to the inner wall of the rotor housing and a lesser diameter at the damper face adjacent to the bearing seat.

11. The rotor according to claim 1, wherein the or each damper is any of a rubber damper, a silicone damper, or a neoprene rubber damper.

12. The rotor according to claim 1, wherein each damper comprises a threaded screw for releasable connection to the bearing seat; and/or each damper comprises a threaded aperture for releasable connection with a screw through the rotor housing.

13. The rotor according to claim 1 comprising between about 10 and about 24 frustoconical dampers arranged annularly.

14. A fiberising apparatus comprising a set of at least two rotors according to claim 1, wherein each rotor is mounted for rotation about a different substantially horizontal axis and arranged such that, when the rotors are rotating, melt poured on to the periphery of the first rotor in the set is thrown successively onto the periphery of each of the subsequent rotors and fibres are thrown off from the rotors.

15. A method of manufacture of man-made vitreous fibres (MMVF comprising:
providing a fiberising apparatus comprising a set of at least two rotors according to claim 1, each mounted for rotation about a different substantially horizontal axis, wherein
each rotor has a drive means;
rotating the rotors;
providing a mineral melt for formation of man-made vitreous fibres (MMVF wherein the melt is poured on to the periphery of the first rotor; and
collecting the fibres formed.

16. The rotor according to claim 1, wherein each resilient damper is frustoconical.

17. The rotor according to claim 13, wherein the frustoconical dampers are equidistant from each other around a substantially annular bearing assembly.
